(19) United States
(12) Patent Application Publication
(10) Pub. No.: US 2006/0122917 A1
(43) Pub. Date: Jun. 8, 2006

(54) Real-time collaborative commerce in a multiple browser environment

(75) Inventors: Ishantha Joseph Lokuge, Redwood City, CA (US); Yin Yin Wong, San Francisco, CA (US); Derek Chung, San Francisco, CA (US); Lalit Balchandani, San Francisco, CA (US); Baldo A. Faieta, San Francisco, CA (US)

Correspondence Address: BEYER WEAVER & THOMAS LLP, P.O. BOX 70250, OAKLAND, CA, 94612-0250, US

(73) Assignee: URBANPIXEL INC, SAN FRANCISCO, CA (US)

(21) Appl. No.: 11/329,845

(22) Filed: Jan. 10, 2006

Related U.S. Application Data
(63) Continuation of application No. 09/925,409, filed on Aug. 8, 2001, now abandoned.
(60) Provisional application No. 60/225,151, filed on Aug. 14, 2000.

(51) Int. Cl. G06F 17/30

(52) U.S. Cl. 705/27

(57) ABSTRACT

A technique is disclosed for facilitating electronic commerce and/or information exchange. The technique of the present invention enables a content provider to create a web space which can surface large amounts of product data into one single view. In addition, the display and layout of the web space may be dynamically customized. Further, if desired, customer specific data may be overlaid on product catalog data. In this way, customers are able to quickly grasp the extent of the virtual store and access products of interest by drilling-down on any single region of the store. Additionally, customer behavior patterns and activities may be tracked in real-time. This information may be used to enable a on-line merchant to respond appropriately, in real-time, in order to facilitate sales of merchandise to current on-line shoppers.

### CROSS REFERENCE TO RELATED APPLICATIONS

The present application is a continuation under 35 U.S.C. §120 of U.S. patent application Ser. No. 09/925,409 (Attorney Docket URBAP003), filed Aug. 8, 2001, which further claims priority under 35 U.S.C. §119 to U.S. Provisional Application Ser. No. 60/225,151 (Attorney Docket No. URBAP003P), naming Wong et al. as inventors, filed Aug. 14, 2000, the entirety of which is incorporated herein by reference in its entirety for all purposes.

The present application also claims priority under 35 U.S.C. §120 to U.S. patent application Ser. No. ______ (Attorney Docket No. URBAP002C1), naming Chung et al. as inventors, entitled, SPATIAL CHAT IN A MULTIPLE BROWSER ENVIRONMENT, filed on Dec. 15, 2005, which is a continuation application of U.S. patent application Ser. No. 09/596,224 filed on Jun. 14, 2000 (Attorney Docket No. URBAP002), which claims benefit to Provisional U.S. Patent Application No. 60/171,840 filed Dec. 22, 1999 entitled, COMMUNITY IN A SHARED MULTIPLE BROWSER ENVIRONMENT, each of which is incorporated by reference herein in its entirety and for all purposes.

This application is related to U.S. patent application Ser. No. 09/596,305, now U.S. Pat. No. 6,708,172 (Attorney Docket No. URBAP001) entitled, COMMUNITY-BASED SHARED MULTIPLE BROWSER ENVIRONMENT, which is incorporated by reference herein in its entirety and for all purposes.

### BACKGROUND OF THE INVENTION

The present invention relates generally to computer networks, and more particularly to techniques for facilitating electronic commerce over a data network.

Applications for facilitating electronic commerce over the Internet and World Wide Web have matured significantly over the last several years. However, the technologies for creating an interactive web experience for end users have not progressed significantly relative to the growth of the Internet. For example, using conventional electronic commerce technology, a customer's on-line shopping experience will typically be limited to a catalog type, passive experience in which the customer is unaware of other on-line customers concurrently visiting the same web site. As a result, on-line merchants typically experience a disappointing conversion of on-line shoppers to on-line purchasers. For example, typically only two percent of shoppers who visit an electronic commerce site become purchasers at that site. Moreover, typically only fifteen percent of the purchasers become repeat visitors to the electronic commerce site.

Accordingly, it will be appreciated that there exists an ongoing desire to improve electronic commerce technology, for example, to provide more enjoyable on-line shopping experiences to end-users, to increase electronic commerce transactions, and to generally improve the “stickiness” of an electronic commerce site.

### SUMMARY OF THE INVENTION

According to several embodiments of the present invention, various methods, systems, and/or computer program products are disclosed for effecting electronic commerce via a data network. The data network includes a server system configured to host a web site associated with a first content provider. The data network further includes a client system configured to implement a browser application, wherein browser application is configured to facilitate access to the web site by a first user. A single graphical spatial environment is provided for simultaneous display of multiple catalog hierarchies. The display of multiple catalog hierarchies includes a plurality of different products corresponding to a plurality of different product categories. The plurality of different products are spatially arranged in manner so as to promote cross-selling of the plurality of different products. According to a specific embodiment, the single graphical spatial environment corresponds to a two-dimensional representation of a floor space of a virtual store.

According to specific embodiments, the multiple catalog hierarchies are displayed as a network of continuous images. In one implementation the displayed catalog hierarchies include, for example, a first department, a first set of categories associated with the first department, and a first plurality of different products associated with each first set of categories; and a second department, a second set of categories associated with the second department, and a second plurality of different products associated with each second set of categories.

In a specific embodiment, a proxy image representing the first user may be displayed within the spatial environment. Additionally, proxy images representing the other on-line shoppers within the spatial environment may also be displayed.

Alternate embodiments of the present invention are directed to a technique for effecting electronic commerce via a data network, wherein a user's shopping activity is monitored in real-time as the user navigates through the web site. According to one implementation, the relative position of a user's current location within the web site may be monitored and tracked in real-time. Additionally, according to a specific embodiment, the length of time that the user remains at a particular location within the web site they also be monitored and/or tracked in real-time

Further embodiments of the present invention are directed to a technique for effecting electronic commerce via a data network, wherein contextual information from the web site which is currently being displayed to a user may be tracked in real-time. For example, in one embodiment, a relative position of the user's current location within the web site may be determined in real-time, and using this information, the contextual information from the web site which is currently being displayed to the first user may then be determined. Additionally, according to a specific embodiment, the technique of the present invention may be used to detect, in real-time, specific customer behavior patterns, and/or portions of the web site which are relatively congested with customer activity. Appropriate action may then be taken in response in order to facilitate sales of merchandise. Such action may include, for example, providing immediate sales assistance to selected on-line customers.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1A shows an example of a conventional web site hierarchy 100.

FIG. 1B shows an example of an on-line merchant's web site 150 implemented in accordance with a specific embodiment of the present invention.

FIG. 2 shows an example of a virtual store web space 200 which has been implemented in accordance with a specific embodiment of the present invention.

FIG. 3 shows an example of an on-line merchant's web space 300 in accordance with a specific embodiment of the present invention.

FIG. 4 shows an example of a contextual navigation map in accordance with a specific embodiment of the present invention.

FIG. 5 shows an example of a store activity display mechanism implemented in accordance with a specific embodiment of the present invention.

FIG. 6 shows a representation of a buddy list display 600 in accordance with a specific embodiment of the present invention.

FIG. 7 shows an example of a bot-proxy 702 in accordance with a specific embodiment of the present invention.

FIG. 8 shows a network device 60 suitable for implementing the electronic commerce techniques of the present invention.

### DETAILED DESCRIPTION OF THE PREFERRED EMBODIMENTS

Reference will now be made in detail to some specific embodiments of the invention. Examples of these specific embodiments are illustrated in the accompanying drawings. While the invention will be described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In today's customer driven information-rich world, presenting and assimilating information using current web technologies is fast reaching its useful limits. Businesses and their customers need to better organize, navigate and visualize all types of data in real-time to respond rapidly to changing market conditions. The visual and interactive techniques of the present invention expand current web technologies to a new level by empowering customers to access, interact and change visual information across intranet, extranet, and commerce applications.

According to specific embodiments, the technique of the present invention provides a mechanism for enabling a new type of interactive web site for facilitating collaborative electronic commerce and/or information exchange. Moreover, the techniques of the present invention as described herein may be used to overcome many conventional problems associated with conventional electronic commerce technology such as, for example, non-contextual hierarchical navigation, limited product merchandising techniques, lack of reactionary sales and on-line customer service capabilities in real-time, restricted capabilities for guided sales processes, solitary customer shopping experience, etc.

In applications where it is desirable to surface relatively large amounts of visual content, the technology of the present invention enables a content provider to create a web space which can surface large amounts of product data into one single view. In addition, the display and layout of the web space may be dynamically customized. Further, if desired, customer specific data may be overlaid on product catalog data. In this way, customers are able to quickly grasp the extent of the virtual store and access products of interest by drilling-down on any single region of the store.

As described in greater detail below, the technique of the present invention provides a number of advantages over conventional electronic commerce techniques. For example, using the technique of the present invention, web site navigation may be improved by surfacing product content onto a single two-dimensional virtual floor space. Additionally, the mapping technology of the present invention enables faster download of web page content. Further, the technique of the present invention provides customers with the ability to dynamically customize their visual experience while navigating through the content provider's web site. The technique of the present invention may also be used to improve visualization by highlighting and abstracting personalized data, and to improve on-line web browsing or shopping collaboration by providing a multi-user shared view of a content provider's floor space.

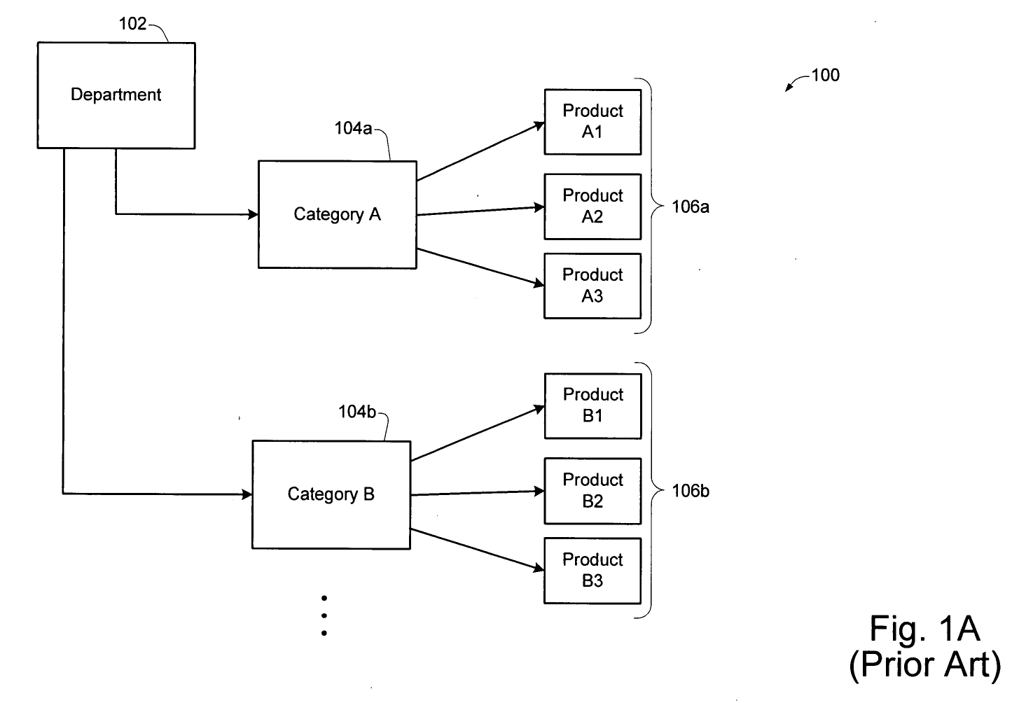

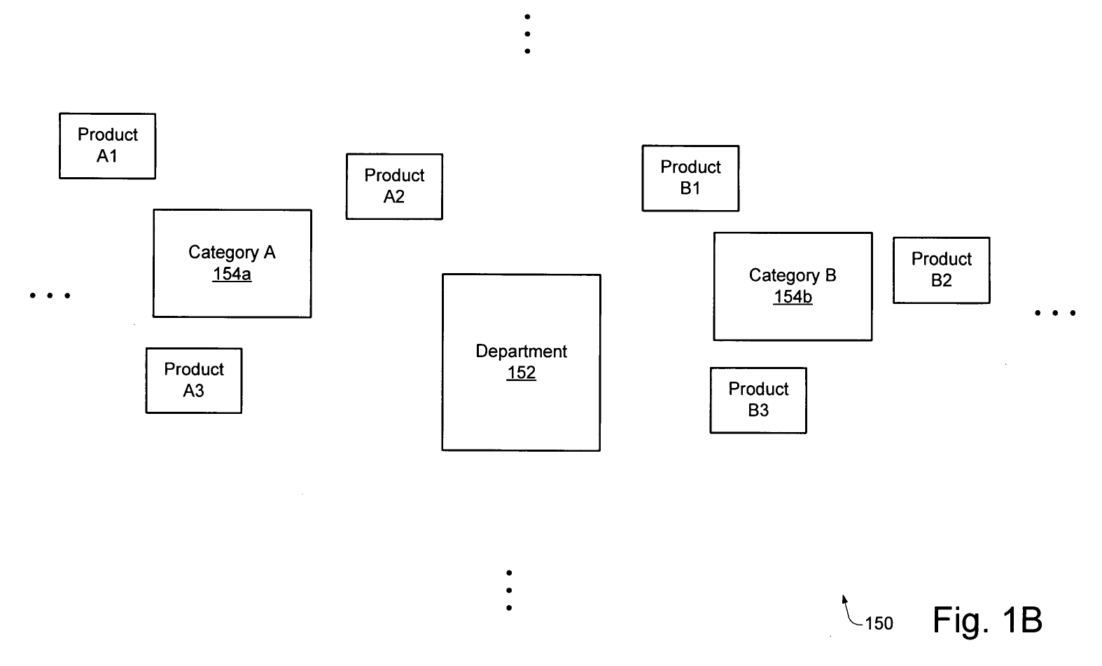

FIG. 1A shows an example of a conventional web site hierarchy 100. Typically, most conventional electronic commerce web sites present either a static textual tree illustrating the different hierarchies of the on-line merchant's catalog, or display the different catalog hierarchies to the user as separate web pages which include embedded links to other web pages in the web site. For example, as shown in FIG. 1A, the web site 100 may include department web page 102, which includes links to individual category web pages 104a and 104b. Each of the category web pages (such as, for example, Category A web page 104a) may display a plurality of product information 106a relating to that specific category, and further may provide links for obtaining additional information about each of the listed products.

FIG. 1B shows an example of an on-line merchant's web site 150 implemented in accordance with a specific embodiment of the present invention. As shown in the example of FIG. 1B, the different catalog hierarchies (e.g. department, category, product) have been aggregated into a single view. According to a specific implementation, the on-line merchant's web site may be implemented as a single web page which represents a two-dimensional floor plan of the on-line merchant's store. In this way, the user is able to view all of the different catalog hierarchies in single representative view. This provides the user with a visual representation of the different catalog hierarchies, and also provides the user with a visual map or layout of the on-line merchant's store. For example, as shown in FIG. 1B, the different categories and products associated with Department 152 are spatially arranged in a manner similar to the spatial arrangement of products in a retail store. This provides the user with visual reference points which aid the user in navigating through the on-line store.

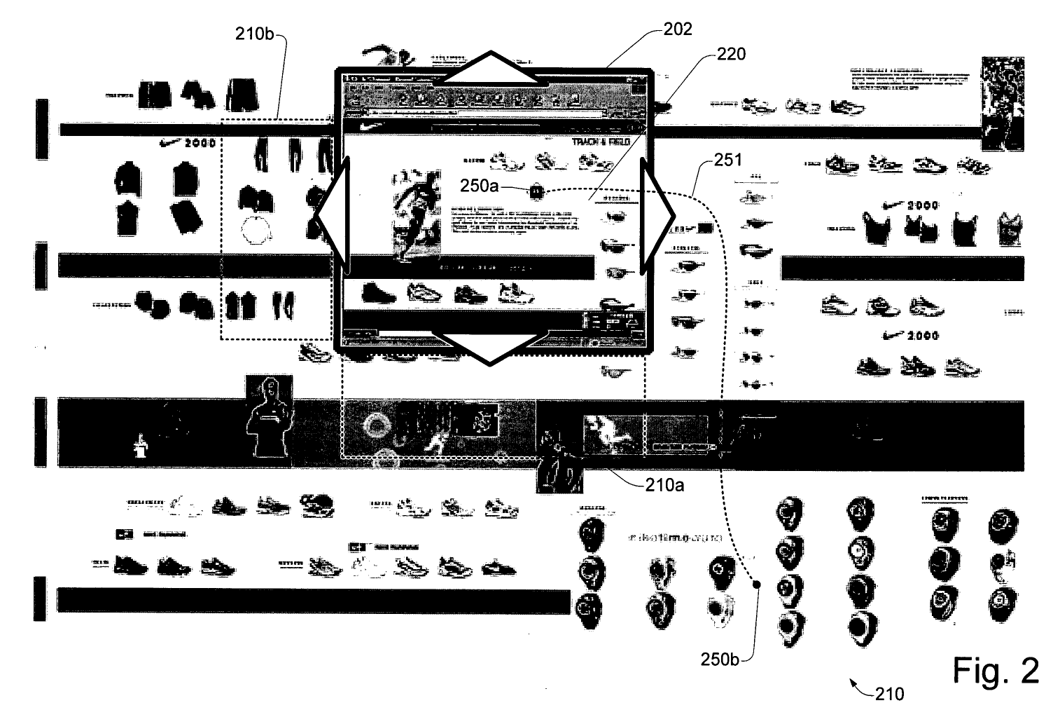

FIG. 2 shows an example of a virtual store web space 200 which has been implemented in accordance with a specific embodiment of the present invention. As shown in FIG. 2, the virtual store web space 200 includes a landscape sheet 210 which, according to a specific embodiment, corresponds to a two-dimensional virtual sheet that hosts multiple tiled browser windows.

According to different embodiments, the landscape sheet may vary in size, ranging, for example, from a size smaller than a traditional browser window to a size which is greater than 200 meters by 200 meters. For example, as shown in FIG. 2, the landscape sheet 210 is about 10 times larger than the size of a conventional browser window 202. Only a portion 220 of the landscape sheet 210 is visible within the browser window 202. In specific embodiments where the landscape sheet 210 corresponds to a single web page, a conventional web browser would typically attempt to download the entire contents of the landscape sheet 210 into its local memory cache, resulting in an undesirably long download time as experienced by the end-user.

However, unlike conventional browsing techniques, the technique of the present invention only downloads a selected portion of the browsing tiles to the user's Internet browser. According to one implementation, the selected portion may be determined based upon the user's desired viewing location within the landscape sheet 210. As the user pans to different regions within the landscape sheet, additional browsing tiles are dynamically downloaded to the user's Internet browser. For example, if the user desires to pan left, the browser tiles of landscape sheet portion 210b may be downloaded to the user's Internet browser and seamlessly displayed in browser window 202. If the user desires to pan down, the tiles from landscape sheet portion 210a may be downloaded to the user's Internet browser and displayed in browser window 202. Thus it will be appreciated that an on-line merchant's virtual floor space may extend beyond the boundaries of a conventional browser window, and that the Internet browser window may be used as a viewport into the virtual store space. The user is able to navigate to different areas within the virtual floor space by panning in a desired direction and/or by clicking on appropriate links or maps of the virtual floor space.

According to a specific embodiment, the on-line merchant's virtual floor space may be implemented using a landscape sheet of the present invention, which is a two-dimensional virtual sheet that hosts multiple tiled browser windows. The size of the landscape sheet may be configured to have any desired dimensions. Moreover, since the on-line merchant is able to display all catalog products on the landscape sheet, there is no longer need to chunk the catalog products into separate web pages for display (as is done in conventional electronic commerce techniques). Using the technique of the present invention, products can be laid out into a continuous two dimensional landscape with navigational controls that enable the user to stroll through the virtual floor space. Thus, according to a specific implementation, the user's Internet browser window may be used to provide a view or window into a much larger virtual space. As the user strolls or pans through the virtual floor space, cells or tiles which store product data are seamlessly brought into view and displayed in the user's browser window. Moreover, using the technique of the present invention, an on-line merchant is able to create a virtual store web space whose layout has a “look and feel” similar to the layout of an actual retail store where merchandise placement, customer service, sales persons, and the presence of other shoppers are part of the user's shopping experience.

In the example of FIG. 2, a portion of a merchant's on-line catalog is laid out much like a shopping floor in a department store. In one implementation, sale and customer support people are readily available to help the customer in real-time, when needed. Using a navigation paradigm of the present invention, a user is able to pan in any direction of the virtual store web space, thereby creating a shopping experience which is similar to the shopping experience of browsing in a retail store. Additionally, as described in greater detail below, on-line merchants are able to leverage the spatial map of the landscape sheet to layout synergistic content/products in order to contextually integrate product information and/or promote cross-sales of different products by visually displaying selected products in close proximity to one another in a manner similar to that implemented in a retail store. For example, merchandise can be displayed next to other merchandise based on sales synergy. This concept has proven effective in retail stores where related goods (e.g. wine and cheese) are placed in close proximity to each other in order to boost the sales of each of the goods.

Additionally, as described in greater detail below, characters and/or symbols may be used to visually represent each or a selected portion of the on-line customers who are currently shopping or browsing the virtual store web space. The location of the other on-line customers may be visually displayed to a user, thereby enhancing the user's on-line shopping experience. According to one implementation, the user may choose to interact (e.g. chat or speak) with other near by on-line shoppers in order to obtain, for example, informal advice, product reviews, etc. The spatial context of such interactions enable users to obtain contextually relevant information from other on-line users in real-time. For example, a user who is browsing in the digital camera department portion of the virtual store web space may see that other on-line customers are also browsing the digital camera department portion of the virtual store web space, and may choose to ask one or more of these other on-line customers for product reviews or other recommendations relating to digital cameras.

In at least one embodiment, the virtual web page of the present invention may be implemented by creating atomic browser units or cells tiled infinitely in the XY plane. Each atomic browsing unit is configured to be relatively smaller than the user's Internet browser window, thereby resulting in many atomic browsing units being displayed in a conventional Internet browser window. In this way, it is possible to change content on just parts of a web page much faster as there is no need to re-generate the entire page as the user navigates around the web page. Rather, according to one implementation, the only browsing tile units which are modified will be those which require updating to display the new information. Thus, for example, when a user pans to a new location within the web page, the only browsing tile units which are downloaded to the user's computer will be those which are to determined to be within the view of the user's Internet browser window. As the user pans to a different region, additional browsing tile units will be downloaded to the user's computer and displayed within the Internet browser window. According to a specific embodiment, each tile is individually editable based on user permissions, and may be populated, for example, via an XML feed.

One advantage of the present invention is that it enables the virtual floor space for displaying merchandise to be as large as desired. In contrast, using conventional techniques, the dimensions of a conventional browser window effectively limit the preferred size of the web page depicting the floor space. Traditionally, the size limitation of the web page is due, at least in part to the fact that most conventional browsers attempt to download the entire contents of a selected web page. Thus, the greater the amount of content on a given web page, the slower the download time. However, unlike conventional techniques, a specific implementation of the present invention downloads only a desired portion of the on-line merchant's web page to the user's Internet browser. Thus, although the on-line merchant's web page may include megabytes of data content, the user will not experience any significant delays in accessing the web page since only a selected portion (e.g. selected frames) of the web page is downloaded to the user's computer at any given time.

It will be appreciated that the technique of the present invention may be used to overcome a variety of other problems and issues associated with conventional electronic commerce techniques. An example of at least a portion of the conventional problems and their solutions using the technique of the present invention is provided below.

A first issue relates to non-contextual hierarchical navigation of conventional web sites. Typically, products which are included in conventional electronic commerce sites are embedded deep within hierarchies of web pages, making it difficult for users to navigate and find desired information. As a result, users who visit electronic commerce sites are typically required to navigate through complicated hierarchies of links and web pages to access desired product data. For example, if a customer is seeking a 3 megapixel digital camera, most retailers use a tree-like navigation schema with a hierarchical drill down such as, for example, “Electronics->Cameras->Digital Camera->3 Megapixel”.

It will be appreciated that this type of navigation schema imposes a number of undesirable characteristics. For example a user may be required to perform multiple clicks prior to finding desired product. Additionally, while navigating through the on-line merchant's web site, the user is typically not provided with any contextual or visual clues as to the user's relative location within the web site at any given time during the navigation process. Additionally, display of product catalog data is frequently chunked into multiple pages, hence fragmenting the user's on-line shopping experience.

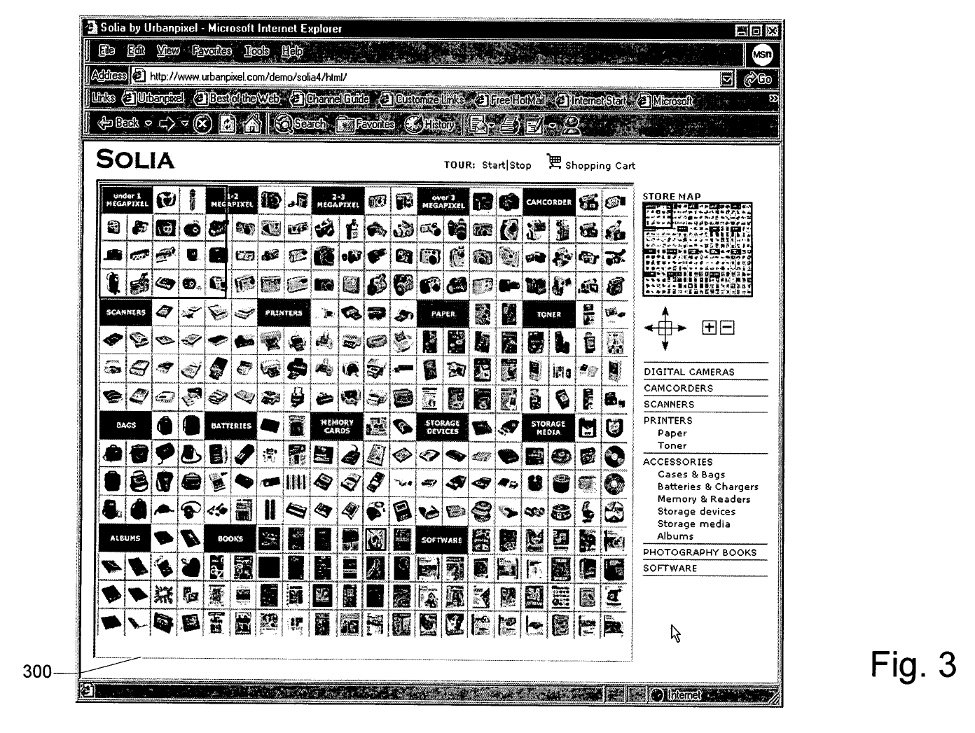

The technique of the present invention provides solutions to such undesirable characteristics, as explained in greater detail below. For example, one feature of the present invention is the ability to provide a user with a visual map of the web site. Thus, rather than embedding products in hierarchies, the present inventive entity has developed a technology that enables electronic commerce sites to surface products in to one global view. An example of this is shown in FIG. 3 of the drawings.

FIG. 3 shows an example of an on-line merchant's web space 300 in accordance with a specific embodiment of the present invention. In the example of FIG. 3, a visual map of the on-line merchant's virtual floor space is displayed, wherein various product categories and sample products are spatially laid out on a two dimensional space of a landscape sheet. In this way, a user may be provided with a quick overview of the store, and can jump to any desired product in a single click.

Another feature of the present invention is the ability to provide a user with contextual navigation tools. For example, as a user clicks on any product in the store map of FIG. 3, a miniaturized version of the floor space or store map may be provided to let the user know of his or her relative location in the on-line store at any time. This help prevent the user from getting lost during the browsing process.

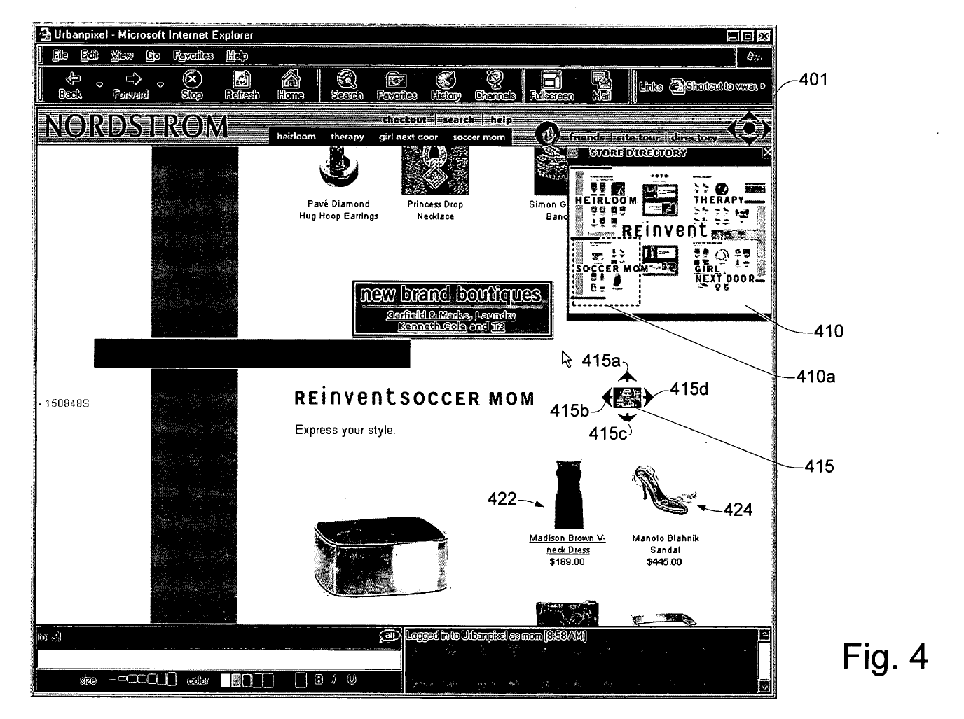

FIG. 4 shows an example of a contextual navigation map in accordance with a specific embodiment of the present invention. In the example of FIG. 4, a portion 402 of an on-line merchant's virtual floor space is displayed within the user's Internet browser window 401. Displayed within the browser window 401 is a miniaturized map 410, which may be configured to display an overview map of all or a selected portion of the on-line merchant's virtual floor space. In the example of FIG. 4, Portion 410a within the overview map 410 represents the portion 402 of the on-line merchant's virtual floor space which is displayed in the user's browser window 401. The mapping technology of the present invention enables meta-data to be overlaid and highlighted on the overview map, which may be updated in real-time, as needed. The overview map also provides a quick navigation aid for allowing the user to jump from one part of the store to another in a single click.

According to a specific embodiment, a map of the virtual store may be generated by drawing abstracted views of each plot (e.g. one or more browser tiles which includes one or more cells) in an image representing the virtual floor space. Each drawn view is placed in the correct position relative to other plots. The level of abstraction can be varied depending on the size of the space and the map. In this way multiple maps may be generated at multiple levels depending on the view size and the level of detail desired. For example, if a plot includes a plurality of products, the map may include a small image or icon which represents the products associated with that particular plot. At higher levels of detail, the image may include more visual detail, and/or the image may be labeled. According to a specific implementation, one or more maps may also be generated for a subset of the virtual floor space, in which the subspace map does not represent the entire space, but instead shows more detail of a section of the space.

The maps may also be regenerated each time the virtual floor space changes. For example, if the space is redesigned, or the product selection changes, the map generation process may be implemented to generate a new floor map reflecting the new layout and product changes. Additionally, the maps may be overlaid with additional information such as, for example, department names for sections of the maps, and/or locations of specific areas, such as, for example, customer service locations or tour origins. The additional information may also reflect activity within the space, such as, for example, locations of users within the space, popular areas, sales and/or other events. These overlays may include additional layers of text or geometric shapes used to indicate the events or entities.

According to specific embodiments, the virtual floor space maps may be generated in any format that can be rendered by a standard Internet browser. For example, the map may be implemented as an image in JPEG or GIF format, or it may be implemented in FLASH format. Each of these formats represent standard formats which are commonly known to one having ordinary skill in the art.

According to one implementation, when a user clicks on an area within the map (or on an image displayed in the map), the click information (including the relative location of the click within the map) is captured and used to determine the new desired location within the virtual store layout that the user has selected. According to a specific embodiment, the user's computer will determine the X-Y coordinates of the user's click, and pass this information to the server, which may then determine the appropriate plots of the virtual floor space to display on the user's machine, based upon the X-Y coordinates. The user's browser window may then be repositioned to display the new desired location within the virtual floor space. According to one implementation, when a user click on a link within the user's browser window (or clicks on a specific area within the floor map), the user's location may be moved along a trajectory which passes through or adjacent to intermediate plots before arriving at the final destination. For example, as shown in the embodiment of FIG. 2, a user who elects to navigate from location 250a to location 250b may be automatically navigated along a path 251. During this navigation process, plots (e.g. showing eyewear products and wristwatch products) which are adjacent to path 251 will appear in the user's browser window, giving the appearance of a seamless stroll from location 250a to location 250b along path 251. Additionally, according to a specific embodiment, a tracking process may log information relating to the user's path from location 250a to location 250b, and may also log all or selected information which appeared in the user's browser window during the navigation, as well as the amount of time that the information was displayed in the user's browser window. In a specific implementation, the logged tracking information may be stored locally on the user's computer, or may be stored remotely on a server system.

Also displayed within the browser window 401 of FIG. 4 is a proxy symbol 415, which represents the user's current location within the floor space of the on-line merchant's virtual floor. A mechanism for generating and maintaining proxy information relating to one or more users is described in U.S. patent application Ser. No. 09/596,305. In the example of FIG. 4, the user's proxy 415 includes navigational arrows 415a-d, which allow the user to pan the virtual floor layout in any desired direction by clicking on the appropriate arrow(s). As described in greater detail below, the user's proxy 415 location provides valuable information to the on-line merchant, which is generally not available using conventional browsing techniques. For example, the user's proxy location within the virtual floor space may be used to provide tracking information to the on-line merchant of the user's behavior. Conventionally, such user tracking information has been generally limited to user implemented clicks and page views displayed to the user. Moreover, conventional tracking techniques do not have the ability to provide information relating to specific contextual information which the user is currently viewing in real-time.

However, the technique of the present invention provides tracking capabilities for determining, in real-time, contextual information which the user is currently viewing. Additionally, the tracking capabilities may also be used to generate a log which provides detailed information relating to the user's shopping activities such as, for example, the browsing path of the user during an on-line shopping session, and the contextual information which was displayed to the user while navigating the browsing path. For example, referring to FIG. 4, the location of the user's proxy 415 reveals, in real-time, that the user is currently viewing products 422 and 424. According to a specific embodiment, the current position of the user's proxy may be plotted or tracked using a two-dimensional coordinate system.

Another feature of the present invention is the ability to provide virtually unlimited two dimensional floor space for allowing on-line merchants to display products and for allowing on-line shoppers to stroll and buy. Thus, unlike current electronic commerce sites, the technique of the present invention make it possible to design stores that mimic the “stroll and buy” experience of conventional retail stores. According to a specific embodiment, the technique of the present invention enables the creation of web sites that extend outside the boundaries of a typical browser.

Another problem with conventional electronic commerce techniques relates to limited product merchandising techniques. For example, using conventional electronic commerce technology it is difficult to design web sites which effectively promote cross-selling and up-selling of products since, typically, it is only possible to display the relationship of one given product to its other synergistic products. For example, if a user searches for a particular book (e.g. Book A, but author X) at Amazon.com, the web site might respond by providing a web page which includes not only information about Book A, but also information relating to other books written by author X. This type of merchandizing technique may be referred to as “linear merchansing,” which implies a one-to-many type cross-selling technique.

In contrast, as explained in greater detail below, the technique of the present invention may be used to provide a many-to-many cross-selling technique, which may be referred to as “non-linear merchandizing.”

According to a specific embodiment, the technique of the present invention is able to provide non-linear merchandising of products by displaying to the user continuous visual and/or spatial images of a network of products, wherein the visual layout of the products suggests product relationships between the various products. Thus, for example, the proximity of products to each other may be used as an indication of how closely the products are related based, for example, on customer buying patterns.

It will be appreciated that the non-linear merchandising technique of the present invention provides a number of advantages over conventional electronic commerce techniques. For example, synergistic merchandising may be implemented more effectively using the technique of the present invention in order to boost product sales. Additionally, the technique of the present invention also allows for dynamic space generation of product displays in real-time.

As described previously, synergistic merchandizing is a productive mechanism for promoting cross-selling of products in retail stores. The technique of the present invention may be used for implementing synergistic merchandising, for example, by enabling an infinite (or any desired size) virtual floor space, where products may be laid out similar to the way they are laid out in retail stores. This is shown, for example, in FIG. 2 of the drawings. As shown in the example of FIG. 2, an example of non-linear synergistic merchandising is illustrated, wherein “related” products may be grouped and/or arranged in close proximity to other products so as to enhance cross-selling opportunities, much like a traditional retail store experience. Moreover, this spatial arrangement of “related” products (based, for example, on customer buying patterns) may used to promote cross-selling of the entire network of products within the portion of the virtual floor space 210.

According to a specific embodiment, the technique of the present invention also allows for dynamic space generation of product displays in real-time. According to one implementation, dynamic space generation may include creating customized product layouts of virtual floor spaces in real-time based on specific criteria such as, for example, user preferences, inventory levels, special promotions, etc. Customers may also impact the layout and generation of floor spaces based on their interaction and/or shopping history with the electronic commerce system.

Another problem with conventional electronic commerce techniques relates to lack of reactionary sales and customer service capabilities. For example, on-line merchants using conventional electronic commerce technology are not able to provide their sales and customer support staff with the necessary information and capabilities to react to traffic patterns on selected parts of their web sites. Part of this problem is attributed to the fact that conventional electronic commerce technology is not able to track, in real-time, the location of each customer visiting their web site, nor is conventional electronic commerce technology able to track, in real-time, specific content which each customer is currently viewing on their web site. As a result, most electronic commerce sites are relatively static in implementation, compared to conventional retail stores where constant monitoring of customer activity is closely followed by attentive sales and customer support staff.

The technique of the present invention provides a solution for enabling on-line merchants to provide their sales and customer support staff with the necessary information and capabilities to react to traffic patterns on selected parts of their web sites. According to one embodiment, this may be accomplished using the various customer tracking techniques of the present invention. For example, as described previously with respect to FIG. 4, a user's proxy 415 location within the virtual floor space may be used to provide tracking information to the on-line merchant of the user's behavior. The tracking information may include, for example, real-time, contextual information which the user is currently viewing. Additionally, the tracking capabilities may also be used to generate a log which provides detailed information relating to the user's shopping activities such as, for example, the browsing path of the user during an on-line shopping session, and the contextual information which was displayed to the user while navigating the browsing path.

According to a specific embodiment, a granular tracking technique may be implemented to enable the on-line merchant to track, at a relatively granular level, each of the products which have been displayed in the user's browser window, including the length of time each product was displayed, if desired. According to one implementation, such tracking features may be implemented using the proxy technology of the present invention (described, for example, in U.S. patent application Ser. No. 09/596,305), which enables electronic commerce sites to monitor where a proxy is at any given time. In one embodiment, the location of a user's proxy within the virtual floor space may be used as an indication of that user's interest in adjacent products.

Additionally, the user tracking information may be logged and processed in order to provide historical views of the products which each user or customer has viewed, either during the current shopping session, and/or previous shopping sessions. According to a specific embodiment, the reporting capabilities of the present invention keep track of all customer interaction behaviors, and summarizes results for subsequent viewing. According to a specific embodiment, the customer tracking information may be may be maintained and stored at the server system. Thus, for example, in one implementation, cookie files (stored locally at the end user's machine) are not used to store the user's shopping activity and tracking information.

Further, according to specific embodiment, the user may elect to customize the display of the virtual floor space, as it appears in the user's Internet browser window. Such customized display features differ from conventional web page customization techniques. For example, conventional techniques for providing customized web pages typically operate by capturing and storing the user's customization preferences in a static file for subsequent used in rendering the user's customized web page. If the user desires to change a customized display feature, the user will typically have to request to update one or more of the customization preferences. Once the updated customization preferences have been saved, the updated customized display features will be implemented. However, conventional web page customization techniques are not able to dynamically determine updated customization preferences for a user, based on the user's actions as the user navigates through a particular web site.

In contrast, the technique of the present invention is able to utilize information relating to a user's actions to dynamically update customization preferences for that user and/or dynamically modify customized information displayed to the user. For example, the user may desire to have specific products or regions of the virtual floor space display highlight. Thus, in one implementation, products from the virtual floor space which are displayed in the user's Internet browser window may be automatically or manually highlighted to indicate that the user has previously viewed these products. Such highlighting operations may be performed on a region-by-region, plot-by-plot, and/or frame-by-frame basis, for example. Additionally, according to a specific implementation, the user may change the spatial layout of information in the virtual floor space which is displayed on the user's computer. For example, the user may elect to display only those items from the virtual floor space which have been previously viewed or highlighted by that user. In a specific implementation, the customer's logged tracking information may be used to perform these functions. In this way, each user is able to customize the display of the virtual floor space in accordance with his or her own preferences.

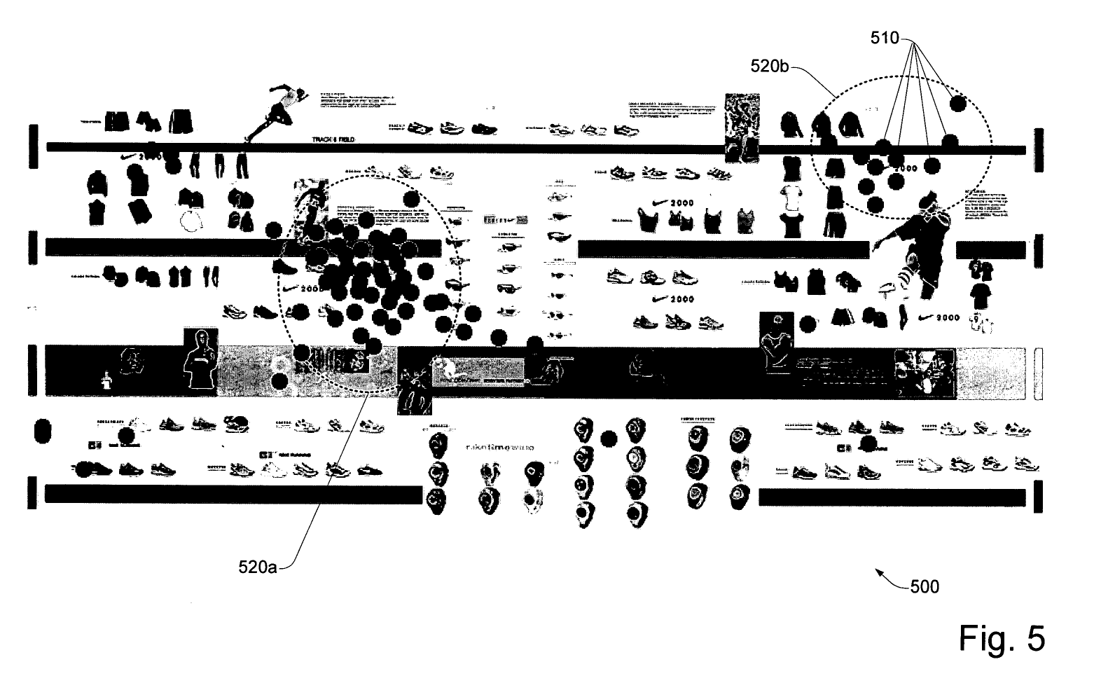

Another technique for enabling on-line merchants to provide their sales and customer support staff with the necessary information and capabilities to react to traffic patterns on selected parts of their web sites is provided by the store activity display mechanism of the present invention. This is shown, for example, in FIG. 5 of the drawings.

FIG. 5 shows an example of a store activity display mechanism implemented in accordance with a specific embodiment of the present invention. As shown in the example of FIG. 5, the store activity display mechanism enables customers (i.e. users), sales staff, and/or customer service personnel to view current store congestion and traffic patterns, in real-time. Thus, it will be appreciated that the store activity display mechanism of the present invention may be used to aggregate, track and display customer activity within the virtual store in a visual and user-friendly manner, thereby providing a visual experience which is similar to that of a traditional retail store, wherein customers, sales staff, and/or customer service personnel are able to see exactly how many customers are in a given department at a given time, and respond appropriately.

For example, referring to FIG. 5, a portion 500 of an on-line merchant's virtual floor space is shown which includes an overlay layer of customer proxy information, showing, in real-time, each customer's current proxy location (510) within floor space portion 500. As can be seen in FIG. 5, regions of 520a and 520b of floor space portion 500 are relatively congested with customers as compared to other regions within floor space portion 500. Each dot 510 of FIG. 5 may be mapped to correspond to a given density of users. For example, for sites with high traffic each dot could represent several thousand users, whereas for lower traffic sites each dot may represent just a single user.

According to one implementation, a sales agent employed by the on-line merchant may monitor the customer activity within all or a designated portion of the virtual floor space, and offer real-time sales assistance to customers located in congested regions of the floor space. For example, in one embodiment, a sales agent may see, in real-time, that region 520a and relatively congested with customer activity, and in response, may broadcast a chat message, in real-time, to each of the customers within region 520a, offering to assist the customer, if he or she desires.

According to an alternate embodiment, an automated process may be used to detect relatively congested regions within the virtual store, and respond with appropriate action, such as, for example, by offering assistance to select the customers within the congested region(s), by offering price reductions of selected products (e.g. products within the congested region(s), and/or related products) to customers within the congested region(s), alerting sales staff of the congested region(s), etc. In this way, the on-line merchant's human resources (e.g. sales staff, customer support staff, etc.) may be effectively utilized and allocated in an efficient manner, thereby resulting in reduced overhead, and more effective use of human resources to facilitate sales and customer service.

Additionally, in one implementation, the automated process may be configured to implement specific actions based upon predetermined business rules being applied to the customer tracking information. For example, a customer may automatically be offered assistance in response to a determination that the customer has been browsing or strolling within the virtual store (or a portion thereof) more than a predetermined or threshold amount of time. Alternatively, for example, a customer may automatically be offered a price reduction for selected products in response to a determination that the customer has been browsing or strolling within the virtual store (or a portion thereof) more than a predetermined or threshold amount of time, and has not yet made a purchase. In one embodiment, if it is determined that the customer has spent greater than a specified amount of time viewing products within a particular department, the customer may be offered a price reduction on one or more of the products within that department in order to encourage the customer to make a purchase. Additionally, product vendors may collaborate with the on-line merchant in order to offer “just in time” sales assistance and/or discounts to customers to help promote sales of that vendor's products.

The store activity display mechanism of the present invention may also be used by customers to get a feel for the “popular” regions within the virtual store. Such information may be used to help the customer to determine where to shop within the on-line store. For example, if a customer sees that a particular department has a relatively large amount of customer activity, the customer may choose to go to that department in order to see what all the “buzz” is about. Moreover, unlike conventional retail stores where the customer would have to compete with other customers in relatively crowded areas, the quality of the customer's on-line shopping experience in not depreciated when the customer enters a relatively congested shopping area within the virtual store.

Another problem with conventional electronic commerce techniques relates to restricted capabilities for guided and/or automated sales processes. Typically, conventional models for on-line shopping are based on a one-to-one sales model, wherein, a given on-line sales agent can communicate (e.g. via telephone or “chat”) with a single customer at a time to resolve any problems that customer may have. While this model works well for one-to-one interaction, it does not support a flexible methodology for one-to-many sales and customer service interaction.

The technique of the present invention provides a solution for enabling on-line merchants to provide enhanced capabilities for guided and/or automated sales processes. For example, according to a specific embodiment, sales and/or customer service agents may be provided with the ability to implement one-to-many type interactions with customers using a guided tour feature of the present invention. According to one implementation, the guided tour feature of the present invention enables an entity (e.g. sales agent, customer service agent, automated agent, customer, etc.) to guide one or more customers through the virtual floor space, wherein the location of each customer's proxy is temporarily controlled by the entity leading the tour. As each customer is guided through the tour, the display in each customer's browser window will change as that customer's proxy location is moved. Tours may be scheduled at stipulated times, or on an “as needed” basis. According to different embodiment, the tours may be statically configured along predetermined paths, or may be dynamically generated in real-time based on customer feedback, for example. Additionally, the members of the tour group may be guided simultaneously to the same locations in the tour, or alternatively, different members of the tour group may be allowed to be at different stages in the tour at any given time.

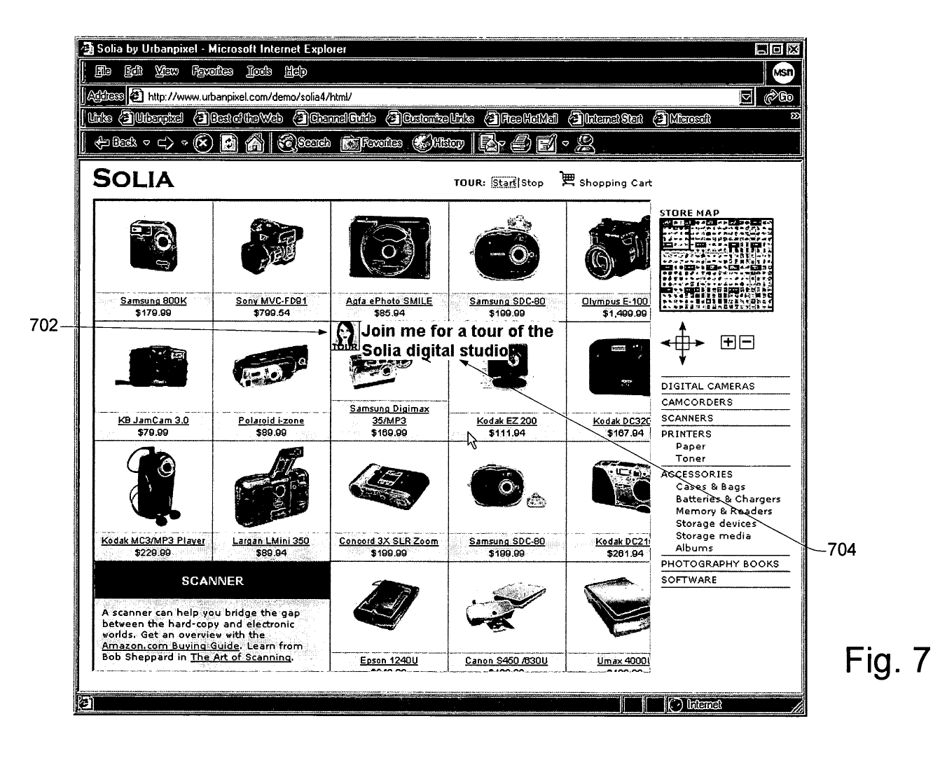

The technique of the present invention may also be configured to implement automated or “bot-guided” tours. In one implementation, such tours may be fully automated to be executed by programmable, automated agents (herein referred to as “bots”). According to a specific embodiment, automated tours may be created within the electronic commerce platform of the present invention by generating “bot-proxies” that are controlled by a program instead of a real person. According to a specific implementation, the bot-proxies and their behavior may be configured to resemble that of a real person to give the impression to the customer(s) that their interacting with a real person. This is shown, for example, in FIG. 7 of the drawings.

FIG. 7 shows an example of a bot-proxy 702 in accordance with a specific embodiment of the present invention. As shown in the example of FIG. 7, the bot-proxy 702 is represented as a proxy much like a sales person would be represented. The communication portion 704 corresponds to a narration or message by the sales person or bot, and may include textual, audio and/or video information which is displayed to the customer. A program may be used to control the location of the bot-proxy, as well as the communications from the bot-proxy to the customer(s). In one implementation, such communications may resemble ordinary sentences similar to those which may be generated by a real person assisting the customer(s). In a specific embodiment, movements and text messages may be generated by the program and sent to a spatial chat server, which forwards them as necessary to nearby users in the landscape to give the appearance of another customer or agent in the virtual floor space.

According to specific embodiment, customers make elect to join a bot-guided tour by clicking on an appropriate symbol or link (herein referred to as a “follow me” link) displayed in the customer's browser window. In specific embodiments where a bot-proxy is programmed to follow a preprogrammed path, and provides uses a “follow me” link to join the tour, the bot-proxy can lead members of the tour on a “tour” of the virtual store. As the bot moves around the virtual space, those customers who have elected to join the tour by clicking on the “follow me” link will have their locations and screens automatically synchronized with the tour leader. Additionally, according to a specific implementation, the location of the tour leader's proxy may be broadcast to nearby customers, including, if desired, customers who are not members of the tour.

In a specific implementation, a bot-guided tour may be customized by specifying a set of points along a desired path of travel. At each point, one or more messages may be broadcast to the tour members while the bot-proxy is at that point. Also, the length of time that the bot-proxy will stay at each point may also be specified. According to a specific embodiment, tour members may individually decided to conduct the tour at their own pace. In such situations, separate instances of the bot-guided tour may be initiated for each member of the tour in order to allow those members to control the pace of his or her own tour. In specific embodiments, each time the bot-proxy guides a tour member to a new location, the tour may temporarily be suspended in order to allow the tour member (i.e. customer) the opportunity to shop or browse products at the new location. When the customer desires to continue on the tour, the customer may click on an appropriate link or symbol which causes the bot-guided tour to resume from the customer's current location.

In at least one implementation, a bot may be configured to respond to input from customers or tour members. For example, if a customer submits a specific request to the bot, (e.g., “Where are the shoes?”), the bot may be configured to dynamically generate and display an appropriate response to the requesting customer (based, for example, on a contextual and/or content analysis of the customer's request) and/or guide the requesting customer's proxy to appropriate locations within the virtual store.

Another problem with conventional electronic commerce techniques relates to the user's solitary shopping experience. For example, conventional electronic commerce shopping techniques are implemented in a manner similar to catalog shopping techniques, wherein a user or on-line shopper will typically view a plurality of product web pages, which is analogous to viewing different pages in a mail-order catalog, for example. Accordingly, it will be appreciated that conventional electronic commerce shopping techniques provide a relatively passive and non-collaborative shopping experience for on-line shoppers. Moreover, while the on-line shopper a shopping at a particular web site, the on-line shopper will typically be unaware of other on-line shoppers who are concurrently shopping at the same web site.

In the real world, however, consumers typically enjoy shopping in the company of others so that they may chat and solicit product feedback other persons, such as, for example, friends, relatives and/or other shoppers. Conventional browsing and shopping solutions are not geared to facilitate this type of interaction in a natural manner.

However, according to different embodiments, the technique of the present invention enables customers to view the presence of other on-line customers, and to communicate with other on-line customers while they shop on-line, even though each customer may physically reside different geographic locations. According to specific implementation, such features may be enabled by providing each customer with a graphical presence in the form of an icon (referred to as a proxy). Each customer's proxy is fully customizable and hence may be easily identified by other customers.

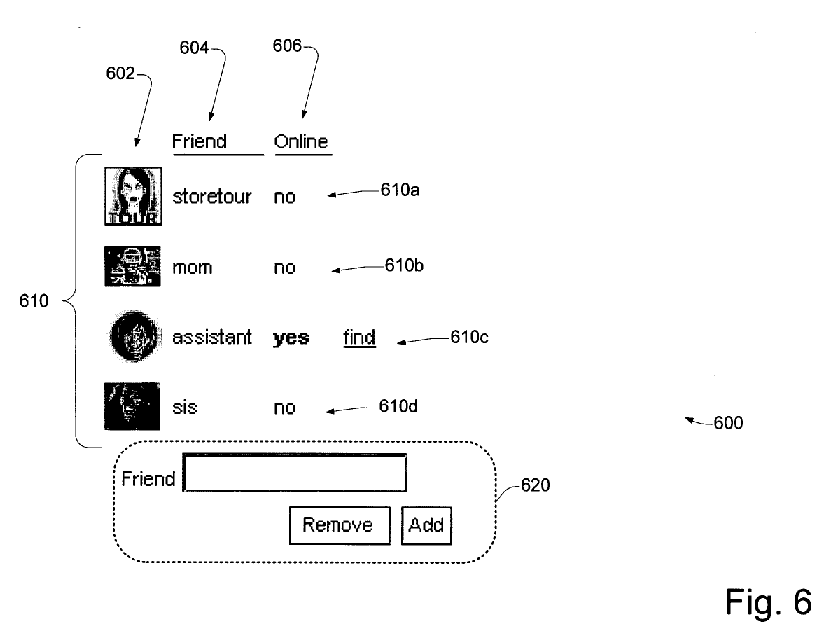

According to at least one embodiment, the technique in the present invention may include additional features to facilitate collaborative shopping and/or other electronic commerce with other customers. For example, customers may create “buddy lists” of friends, family, and/or other customers for facilitating communication (e.g. text or voice chat) with those persons, and for receiving notification when specific members of the buddy list are currently on-line. An example of these features is shown in FIG. 6 of the drawings.

FIG. 6 shows a representation of a buddy list display 600 in accordance with a specific embodiment of the present invention. As shown in the embodiment of FIG. 6, the buddy list display 600 may include a plurality of entries 610, which represent, for example, customers, friends, relatives, or other entities which have been added to the buddy list by a specific user. Each entry in the buddy list display may include, for example, a graphical image or proxy 602 of the person or entity associated with that entry, a customized text description 604 of the person or entity associated with that entry, an on-line status field 606 for indicating whether the person or entity associated with that particular entry is currently on-line, and other parameters, if desired (e.g. a “find” link for finding a particular customer, customer service agent, sales agent, etc.). Additionally, as shown in FIG. 6, the buddy list display 600 may include a search component 620 for locating specific customers or entities, and may additionally include functionality for adding new entries to the buddy list, removing entries from the buddy list, modifying entries in the buddy list, etc.

Another feature of the collaborative shopping technology of the present invention relates to the ability of customer proxy to be remotely controlled by other customers. For example, a customer may be enabled to remotely guide selected “buddies” through the virtual floor space. Additionally, mutual friends or buddies may elect to stick together as a group as they browse the virtual floor space. For example, in a specific implementation, a first customer may invite other customers to follow the first customer by displaying a “follow me” link next to the first customer's proxy. When a second customer clicks on the “follow me” link, a “follow me” procedure may be initiated, wherein the system may create a bonded relationship between the two customer proxies, with the originator having the ability to lead the follower through different areas of the virtual store.

One advantage provided by the technology of the present invention is that allows customers to obtain product opinions and other information from other on-line customers in the context of specific shopping activities and virtual store departments.

### Other Embodiments

Generally, the mapping techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the electronic commerce technique of this invention may be implemented on a general-purpose programmable machine selectively activated or reconfigured by a computer program stored in memory. Such programmable machine may be a network device designed to handle network traffic, such as, for example, a router or a switch. Such network devices may have multiple network interfaces including frame relay and ISDN interfaces, for example. Specific examples of such network devices include routers and switches. For example, various aspects of the present invention may be implemented on specially configured routers or servers. A general architecture for some of these machines will appear from the description given below. In an alternative embodiment, the electronic commerce technique of this invention may be implemented on a general-purpose network host machine such as a personal computer or workstation. Further, the invention may be at least partially implemented on a card (e.g., an interface card) for a network device or a general-purpose computing device.

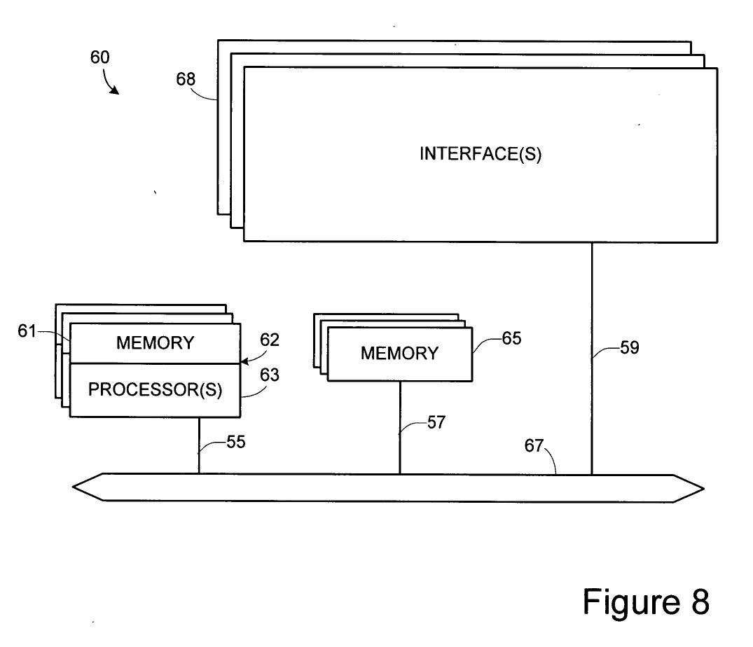

Referring now to FIG. 8, a network device 60 suitable for implementing the mapping techniques of the present invention includes a master central processing unit (CPU) 62, interfaces 68, and a bus 67 (e.g., a PCI bus). When acting under the control of appropriate software or firmware, the CPU 62 may be responsible for implementing specific functions associated with the functions of a desired network device. For example, when configured as a server device, the CPU 62 may be responsible for analyzing packets, encapsulating packets, forwarding packets to appropriate network devices, responding to HTTP requests, etc. The CPU 62 preferably accomplishes all these functions under the control of software including an operating system (e.g. Windows NT), and any appropriate applications software.

CPU 62 may include one or more processors 63 such as a processor from the Motorola family of microprocessors or the MIPS family of microprocessors. In an alternative embodiment, processor 63 is specially designed hardware for controlling the operations of network device 60. In a specific embodiment, a memory 61 (such as non-volatile RAM and/or ROM) also forms part of CPU 62. However, there are many different ways in which memory could be coupled to the system. Memory block 61 may be used for a variety of purposes such as, for example, caching and/or storing data, programming instructions, etc.

The interfaces 68 are typically provided as interface cards (sometimes referred to as “line cards”). Generally, they control the sending and receiving of data packets over the network and sometimes support other peripherals used with the network device 60. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 62 to efficiently perform routing computations, network diagnostics, security functions, etc.

Although the system shown in FIG. 8 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device.

Regardless of network device's configuration, it may employ one or more memories or memory modules (such as, for example, memory block 65) configured to store data, program instructions for the general-purpose network operations and/or other information relating to the functionality of the mapping techniques described herein. The program instructions may control the operation of an operating system and/or one or more applications, for example. The memory or memories may also be configured to

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave travelling over an appropriate medium such as airwaves, optical lines, electric lines, etc. Examples of program instructions include both machine code, such as produced by a compiler, and files containing higher level code that may be executed by the computer using an interpreter.

According to specific embodiments, the techniques of the present invention may be implemented using well-known, conventional platforms such as, for example, XML, Java, JavaScript and DHTML. Further, according to a specific embodiment, the various aspects of the present invention may be implemented in conventional systems without requiring the use of plug-ins. Further, according to different embodiments, the technology of the present invention may either be adopted as an ASP or via a software license. In a specific embodiment, the technique of the present invention may be implemented on a server system which is accessible by Internet end-users. The technique in the present invention may be configured to be compatible with conventional Internet browser applications such as, for example, Internet Explorer and Netscape Navigator. Thus, according to at least one embodiment, conventional Internet browser applications may be used to implement various aspects of the present invention without requiring use of additional software or plug-ins.

In at least one embodiment, specific user information may be stored locally within a cookie or file on the user's computer. Such information may include, for example, user specific registration information (e.g. username, user ID, password, etc.), and information relating to the user's proxy location during the current and/or previous browsing session with a particular web site.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A method for effecting electronic commerce via a data network, the data network including a server system configured to host a web site associated with a first content provider, the data network further including a client system configured or designed to implement a browser application, the browser application being configured or designed to facilitate access to the web site by a first user, the method comprising:
determining, in real-time, contextual information from the web site which is currently being displayed to the first user; and
using the determined contextual information, in real-time, to take appropriate action to help facilitate a sale to the first user.

2. The method of claim 1 further comprising:
tracking, in real-time, a relative position of the first user's current location within the web site; and
determining, using the relative position of the first user's current location, the contextual information from the web site which is currently being displayed to the first user.

3. The method of claim 1 further comprising logging information relating to specific products from the web site which were actually displayed on the client system.

4. The method of claim 1 further comprising tracking, in real-time, content from the web site which is currently being displayed to the first user.

5. The method of claim 1 further comprising:
detecting, in real-time, at least one area of the web site which is relatively congested with customer activity; and
responding to the detection of a relatively congested area of customer activity in order to facilitate sales of merchandise.

6. The method of claim 5 wherein the response includes automatically dispatching at least one automated sales agent to assist at least one on-line customer currently shopping within the relatively congested area.

7. The method of claim 5 wherein the response includes dispatching at least one customer service agent to assist at least one on-line customer currently shopping within the relatively congested area.

8. The method of claim 1 further comprising:
determining that the first user has been browsing within the web site more than a predetermined amount of time; and
responding to a determination that the first user has been browsing within the web site more than a predetermined amount of time by taking appropriate action to help facilitate the first user making a purchase.

9. The method of claim 8 wherein the appropriate action includes providing sales assistance to the first user.

10. The method of claim 8 wherein the appropriate action includes offering to the first user a discount on at least one product displayed within web site.

11. The method of claim 1 further comprising:
determining that the first user has spent more than a predetermined amount of time within a first portion of the web site; and
responding to a determination that the first user has spent more than a predetermined amount of time within a given portion of the web site by taking appropriate action to help facilitate the first user making a purchase.

12. The method of claim 11 wherein the appropriate action includes providing sales assistance to the first user.

13. The method of claim 11 wherein the appropriate action includes offering to the first user a discount on. at least one product displayed within the first portion of the web site.

14. A computer program product, the computer program product including a computer usable medium having computer readable code embodied therein, the computer readable code comprising computer code for implementing the method of claim 1.

15. A system for effecting electronic commerce via a data network, the data network including a client system configured or designed to implement a browser application, the browser application being configured or designed to facilitate access to web sites by a first user, the system comprising:
at least one processor;
at least one interface configured or designed to provide a communication link to at least one other network device in the data network; and
memory;
the system being configured or designed to host a web site associated with a first content provider,
the system being further configured or designed to determine, in real-time, contextual information from the web site which is currently being displayed to the first user;
the system being further configured or designed to use, in real-time, the determined contextual information, to take appropriate action to help facilitate a sale to the first user.

16. A system for effecting electronic commerce via a data network, the data network including a server system configured to host a web site associated with a first content provider, the data network further including a client system configured or designed to implement a browser application, the browser application being configured or designed to facilitate access to the web site by a first user, the system comprising:
means for determining, in real-time, contextual information from the web site which is currently being displayed to the first user;
means for tracking, in real-time, a relative position of the first user's current location within the web site; and
means for determining, using the relative position of the first user's current location, the contextual information from the web site which is currently being displayed to the first user.
